(19) United States
(12) Patent Application Publication
(10) Pub. No.: US 2012/0099334 A1
(43) Pub. Date: Apr. 26, 2012

(54) EMERGENCY LIGHTS MOUNTING APPARATUS AND METHOD OF APPLICATION TO A VEHICLE

(76) Inventor: Rich D. Bourgeois, JR., Goffstown, NH (US)

(21) Appl. No.: 12/908,260

(22) Filed: Oct. 20, 2010

(51) Int. Cl. B62J 6/00; B23P 17/04

(52) U.S. Cl. 362/473; 29/525.01

(57) ABSTRACT

An emergency light system for increasing the visibility of emergency vehicles and the operators to oncoming traffic, the apparatus and method relating to such mounting and light fixtures for a system adapted for use on a vehicle such as a motorcycle to provide constant and uniform 360 degree illumination without gaps in the illumination around the entire circumference of the vehicle.

### FIELD OF THE INVENTION

The present invention pertains to an emergency light system for increasing the visibility of emergency vehicles and the operators to oncoming traffic. More particularly, the apparatus and method relates to such mounting and light fixtures for a system adapted for use on a vehicle such as a motorcycle to provide constant and uniform 360 degree illumination without gaps in the illumination.

### BACKGROUND OF THE INVENTION

Comparatively small strobe flash lamp assemblies incorporating parabolic reflectors and front lenses have been used for a number of years on emergency vehicles such as police cars, police motorcycles, ambulances and fire engines. The high intensity, focused pulsed output of the strobe lamp assemblies provides a readily noticed warning to motorists who must yield to the emergency vehicle. Due to the lack of protection afforded to a police officer riding a motorcycle and due to the small size of a motorcycle in comparison to other emergency vehicles, police officers responding to emergencies on a motorcycle have experienced a comparatively high accident rate. Even though the installation of strobe warning lights on motorcycles has reduced the accident rate in comparison to motorcycles utilizing lower intensity incandescent warning lamps, the accident exposure problem of motorcycles and other emergency vehicles has not been solved.

Emergency lighting systems for vehicles are well known, such as light bars for emergency vehicles which are generally mounted atop vehicles and house strobe lights which timely and cyclically flash in various different colors and at various levels of brightness and illumination to alert passersby and oncoming traffic as to the presence of the emergency vehicle. It is also known for other types of lights and flashing light systems to be mounted on the dash, side panels or mirrors of the emergency vehicle or even inside the vehicle for instance on the visor.

A desirable feature of an efficient emergency light system is that it is capable of being viewed from 360° around the entire vehicle. Until now, this is accomplished by merely placing as many lights as possible upon the vehicle so that there is hopefully some light visible at different points around the vehicle. Such numerous side-marker lights and their relative intensities have heretofore consisted of various different lights from headlights and tail lights to side-marker lights and strobe lights which all utilize different intensities, illumination fans and brilliance characteristics. A need exist for positioning and alignment of vehicle lighting to more completely illuminate the area surrounding the emergency vehicle to better protect vehicle operators, police officers and other emergency personnel from oncoming traffic.

### OBJECT AND SUMMARY OF THE INVENTION

The general objective of the present invention is to provide an emergency light system which improves over certain functions of the prior art in a convenient, efficient and economical manner.

Another object of the invention is to provide emergency light systems which include an improved consistent illumination fan and when arranged accordingly on the vehicle augments the lighting efficiency around the entire vehicle.

A still further object of the invention is to provide a mounting system which is quickly and easily connectable to common vehicle components and a mount which accounts for the significant vibrations created by police motorcycles. In one specific aspect of the invention the mounts enable an LED type light including a consistent 180° output to be appropriately arranged about the entire circumference of the vehicle so as to overlap with the light output of adjacent lights in order to provide 360° constant illumination output around the entire vehicle.

The present invention is directed to an apparatus for mounting emergency lights to a motorcycle comprising a plurality of light sources providing an illumination fan of approximately 180 degrees from each light source; a mounting plate comprising a support surface for securely attaching the light source to the mounting plate; at least a support bracket for removably affixing the mounting plate to a support structure on the motorcycle; and wherein each of the plurality of light sources direct their respective illumination fan substantially equally on either side of a central illumination axis and the central illumination axis of each light source is directed at an angle of less than 90 degrees relative to a longitudinal axis of the motorcycle.

An apparatus for mounting emergency lights to a motorcycle comprising a plurality of light sources providing an illumination fan of approximately 180 degrees from each light source; a mounting plate comprising a support surface for securely attaching the light source to the mounting plate; at least a support bracket for removably affixing the mounting plate to a support structure on the motorcycle and an elastic insulator positioned between the support bracket and the support structure of the motorcycle to facilitate secure attachment and vibration damping between the support bracket and support structure; and wherein each of the plurality of light sources direct their respective illumination fan substantially equally on either side of a central illumination axis and the central illumination axis of each light source is directed at an angle of less than 90 degrees relative to a longitudinal axis of the motorcycle to ensure that each of the illumination fans of adjacent respective light sources overlap to provide illumination around the entire circumference of the motorcycle.

The invention is further directed to a method of mounting emergency lights to a motorcycle comprising the steps of providing a plurality of light sources, each light source defining an illumination fan of approximately 180 degrees emanating from each light source; attaching a mounting plate comprising a support surface to each light source for securely attaching the light source to the mounting plate; removably affixing the mounting plate to a support structure on the motorcycle with a support bracket and positioning an elastic insulator between the support bracket and the support structure of the motorcycle to facilitate secure attachment and vibration damping between the support bracket and support structure; and directing an illumination fan of each of the respective plurality of light sources substantially equally on either side of a central illumination axis of the light source and the central illumination axis of each light source is directed at an angle of less than 90 degrees relative to a longitudinal axis of the motorcycle to ensure that each of the illumination fans of adjacent respective light sources overlap to provide illumination around the entire circumference of the motorcycle.

These and other features, advantages and improvements according to this invention will be better understood by reference to the following detailed description and accompanying drawings.

### BRIEF DESCRIPTION OF THE DRAWINGS

The invention will now be described, by way of example, with reference to the accompanying drawings in which:

FIG. 1A is an exploded view of a light for use with a mount supporting an illumination angle of 180 degrees;

FIG. 1B is a diagrammatic representation of a light having an illumination angle of 180 degrees;

FIG. 2 is an isometric view of the light supported on the mount of a vehicle;

FIG. 3 is a top plan view of the application of the mount and 180 degree illuminating lights to the vehicle; and

FIG. 4A is a top planar view of an embodiment of the present invention using three 180 degree illuminating lights;

FIG. 4B is a top planar view of an embodiment of the present invention using four 180 degree illuminating lights

FIG. 4C is a top planar view of an embodiment of the present invention using four 180 degree illuminating lights.

### DETAILED DESCRIPTION OF THE INVENTION

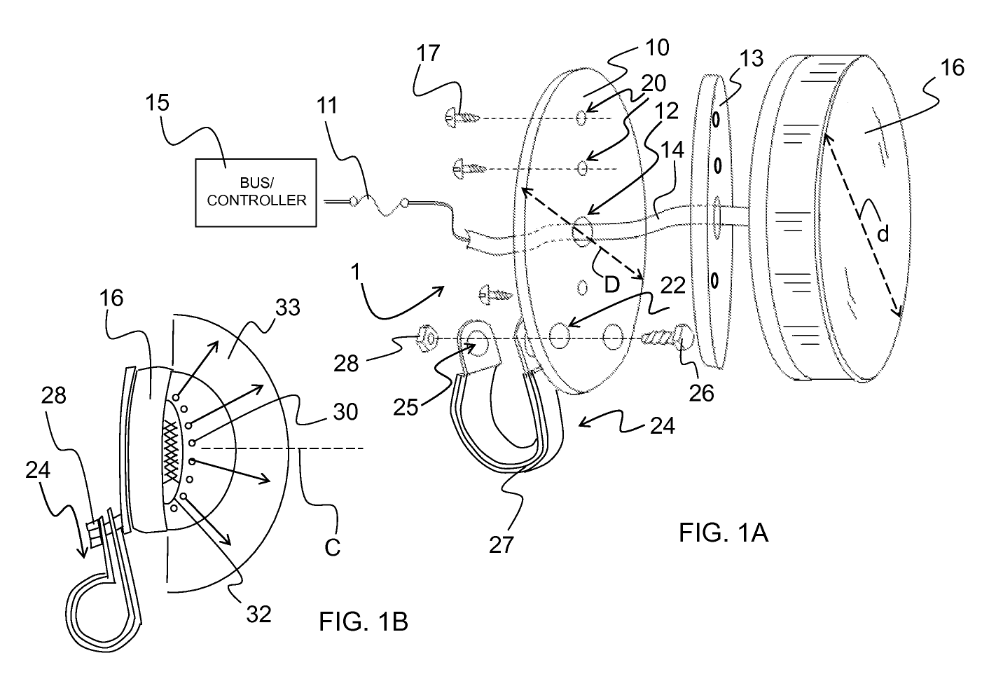

The emergency light apparatus and system of the present invention includes a mounting apparatus 1 for securing an emergency light, particularly a light which disperses its light rays at 180 degrees relative to the motor vehicle as shown in FIG. 1A. In one embodiment the mounting apparatus 1 is specifically designed to mount the emergency lights to the crash bars of a police motorcycle although other alternative uses are imagined for example marine and boat or all-terrain vehicle (ATV) applications using such emergency lights. The apparatus 1 includes a mounting plate 10 having a central aperture 12 formed almost directly in the center of the mounting plate to accommodate the electrical wires 14 and components for operating the emergency light 16. It is to be appreciated that this aperture 12 may also be formed at other parts of the mounting plate 10 depending on the specific location the electrical wires 14 and conduit originate from and are attached to the emergency light itself. The aperture 12 is located so as to facilitate the flush mounting and engagement of the emergency light 16 to the mounting plate 10. After passing through the aperture 12 the electrical wires 14 generally communicate with a fuse box 11 and/or a bus/controller 15 shown diagrammatically here such that the emergency lights may be operated when necessary.

The mounting plate 10 is further provided with a plurality of light mounting apertures 20 which are intended to facilitate engagement with either an intermediate spacer or shim 13, or directly with the light 16 itself to secure the light 16 (and spacer) to the mounting plate 10. The intermediate spacer 13 is generally a plastic spacer between the light 16 and the mounting plate 10 which acts as a base for the light 16 and may provide a passage for the wiring harness to pass out to the side of the light 16 and/or an angled seating arrangement so the light 16 is set on a plane angled relative to a plane defined by the mounting plate 10 itself. The light 16 may attach in any known fashion to the spacer 13 so that it is securely affixed thereto. The mounting apertures 20 may be formed to receive a screw 17 or other type of removable securing means by which the spacer 13 and/or the light 16 is directly secured to the mounting plate 10. Additionally, a number of support bracket apertures 22 are formed spaced apart and adjacent an outer edge of the mounting plate 10. The mounting plate 10 is also provided with a diameter D which is slightly larger than the diameter d of the light 16. The mounting plate 10 is made of aluminum or other metal alloy that is more resistant to vibration than the plastic spacer 13 and that can protect the light if the motorcycle falls on its side. The rigidity and sturdiness of a metal mounting plate with the larger diameter D can absorb vibrations and an impact to the mounting apparatus 1 helping to prevent damage to the light 16.

The support bracket apertures 22 enable a support bracket 24 to directly engage and support the mounting plate 10, and hence the light 16, on desired vehicle components, for example on the crash bar(s) of a motorcycle. The support brackets 24 are flexible in that they are designed to be circumferentially formed around and generally conform to different types of components or different cross-sections and sizes of motorcycle crash bars and crash bar shapes and still securely engage the mounting plate 10 so that the mounting plate 10 and light 16 do not move out of a desired, predetermined position relative to the crash bar and motorcycle.

The support brackets 24 are generally metal and provided with a first and second end with a passage 25 each of which engage the opposing sides of the mounting plate 10 at a respective support bracket aperture 22. A securing bolt 26 may be inserted through the passage 25 in the first and second ends and also through the aperture 22 in the mounting plate 10 and thus secure the support brackets 24 to the mounting plate using a nut 28. The bolt 26 may be for example a ¼ inch by ¾ inch stainless or grade (5) hardened steel bolt. Additionally, the support brackets 24 are at least partially encased by a vibration insulator 27 such as an elastic shim sandwiched between the support bracket and the vehicle component, e.g. the crash bar. The elastic shim or insulator 27 is important with respect to for example a police motorcycle because of the very high vibration frequency from the engine which is transmitted directly to the motorcycle frame and the crash bars. It is generally standard operating procedure for emergency vehicles including motorcycles to most often be kept running during an event in which the emergency lights are used so that the vehicle battery is not run down. The elastic shim or a similar material insulator 27 between the support brackets 24 and the crash bar helps to reduce the transmission of mechanical vibrations from the vehicle to the emergency light.

In one embodiment of the present invention the vibration insulator 27 can cover not only the inner side of the support bracket 24 between the crash bar and the bracket, but also the outer side of the support bracket 24 as well. This is important because a portion of the mounting plate 10 may in some circumstances directly touch the outer side of the support bracket 24 and the insulator material 27 when provided on the outer side of the support bracket provides an elastic buffer between the mounting plate 10 and the outer side of the support bracket 24. This arrangement helps eliminate metal on metal contact where vibrations from the motorcycle could damage the metal surfaces and such vibrations can be better absorbed by providing the elastic insulator material 27 between the metal surfaces of the mounting plate 10 and the outer side of the support bracket 24.

The emergency lights 16 of the present invention are specifically designed to direct the illumination and visible light waves from a plurality of light emitting diodes (LED's) 30 in a 180 degree arc as seen in FIG. 1B. This specific illumination fan 33 is helpful in that the light waves emanating in the 180 degree arc can be specifically directed by the use of for example a convex reflector 32 arranged with and between the LED's and ensures that the LED illumination is decollimated and directed at a desired angle away from and relative to the motorcycle. This is extremely helpful to the operator of the motorcycle or other type of vehicle so they are not unduly affected by back glare or direct light waves from the emergency light 16 when the direction of the light waves emanating from the emergency lights is directed essentially entirely away from the vehicle.

The use of a pair of support brackets 24 as described above is also important because it ensures that the light 16 and its resultant illumination fan 33 is maintained in a desired angular orientation relative to the motorcycle. It is possible to use only a single support where space constraints may dictate, and where for example on the front crash bars the vibration is lower because most of the vehicle vibration is caused by the exhaust and is thus stronger towards the rear of the motorcycle where the larger exhaust pipes are positioned. However, where only a single support point for the mounting plate 10 is provided, the light 16 and mounting plate 10 could be rotated about the single support point when bumped or vibrated. The use of two attachments points and two spaced apart support bracket apertures 22 ensures that the mounting plate 10 and the light affixed thereto cannot be easily moved out of a predetermined alignment relative to the motorcycle, even if the support points loosen due to vibration, to maintain the necessary complete 360 degree illumination of the vehicle as discussed below in further detail.

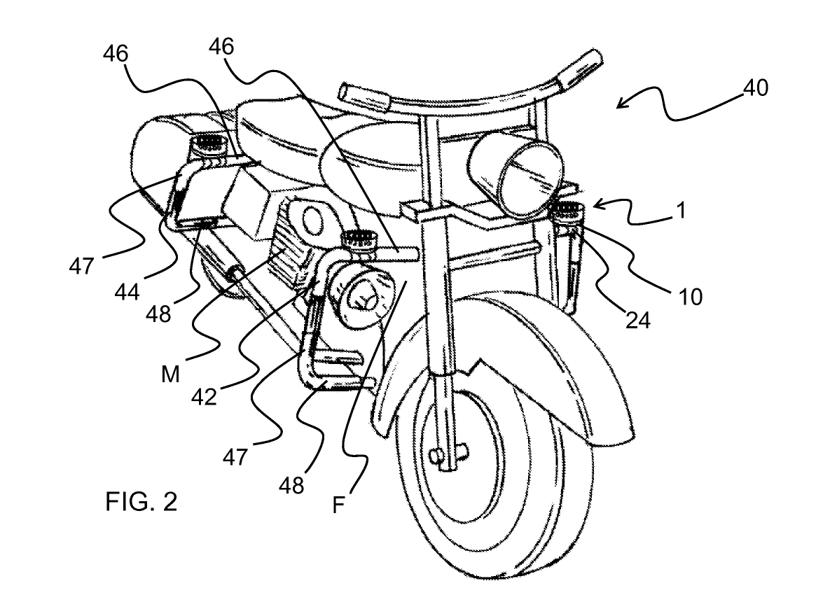

As seen in FIG. 2 for a motorcycle 40, the mounting plate 10 and lights 16 are attached to the front and rear crash bars 42, 44 of the motorcycle 40. The front and rear crash bars 42, 44 for a motorcycle 40 are designed to protect the rider the motorcycle 40 in the event of a crash or even if the vehicle falls or tips over when at rest. The crash bars 42, 44 are generally connected to the frame F having a top horizontal section 46 of the crash bar extending outwards from a connection point to the frame F and at a point distal from the frame F turning downwards to a substantially vertical section 47 which in turn bends inward to again connect along a lower horizontal section 48 to the motorcycle frame F. The vertical section 47 is spaced far enough from the frame F to protect the rider's legs and the motor M from directly contacting the ground in the event the motorcycle falls on its side. The rear crash bars 44 are similarly mounted with top, vertical and lower sections, and similarly referenced as 46, 47 and 48, as the front crash bars 42, connected to the frame F towards the rear of the motorcycle 40. Together the front and rear crash bars 42, 44 prevent damage to the rider's legs, and/or the motor M and other components of the motorcycle in the event of a crash, or the vehicle being struck or merely falling over.

The crash bars 42, 44 are advantageous support structures for the mounting apparatus 1 since they provide a substantial length along which the mounting plate 10 can be connected and arranged onto the motorcycle 40. The mounting plate 10 would generally be connected to the top horizontal section 46 or on the vertical section 47 of the crash bar by the support brackets 24 being fastened around the desired section of the crash bar 42, 44. The securing bolt 26 would then be inserted through the passage 25 in the first and second ends and also through the aperture 22 in the mounting plate 10 and the tightening of a nut 28 on the bolt 26 would securely tighten the support brackets 24 around the crash bar as well as securing the mounting plate 10 in a desired orientation relative to the crash bar 42, 44.

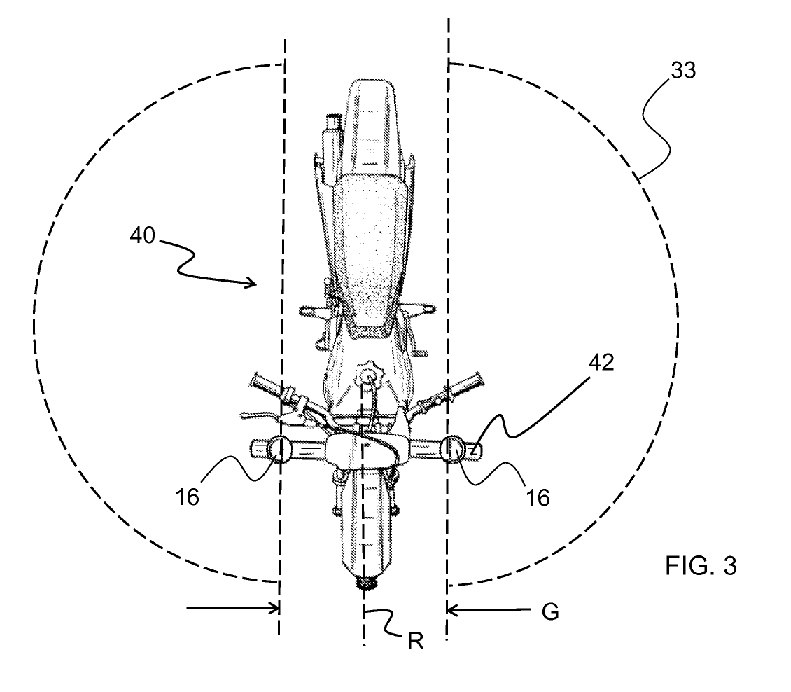

In a first configuration a mounting plate 10 would be oriented so that the 180 degree light would illuminate the entire opposing sides of the motorcycle as seen in FIG. 3. In this orientation with the centerline C of each 180 degree light extending perpendicular, i.e. 90 degrees, to the longitudinal axis R of the motorcycle 40, the illumination is directed outwards from the sides of the motorcycle 40 in a 180 degree fan. The light rays, and hence the illumination, which are directed at 180 degrees outward radially from the light 16 in this case however do not overlap, or intersect, and so there is an illumination gap G in the front and rear of the motorcycle. This creates a safety concern with directly oncoming traffic facing the front and rear of the motorcycle. It is to be appreciated that the shown arc of the light fan 33 in the figures is not the limit of the visible light rays emanating from the light 16, but merely a diagrammatic representation of the 180 degree angle at which the light rays are directed from the LED light 16.

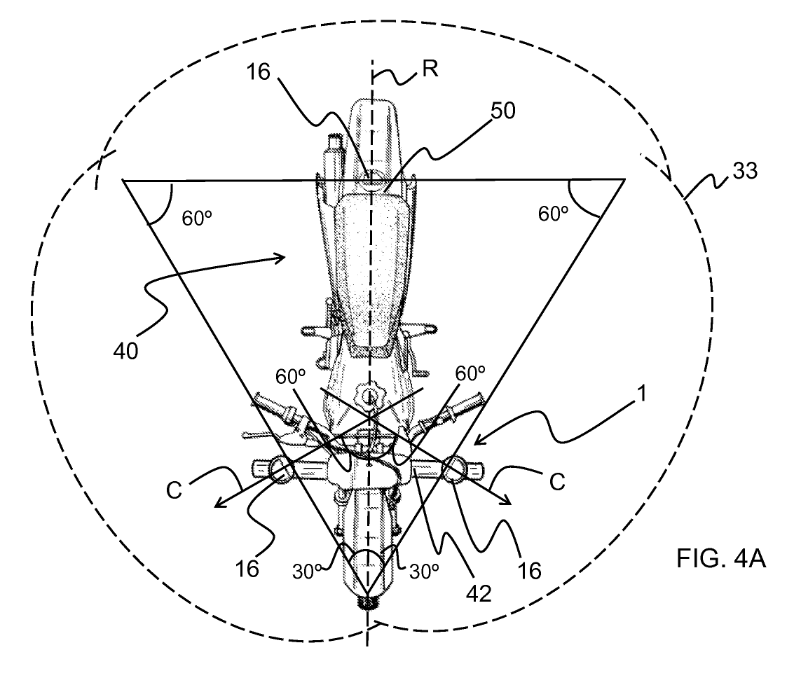

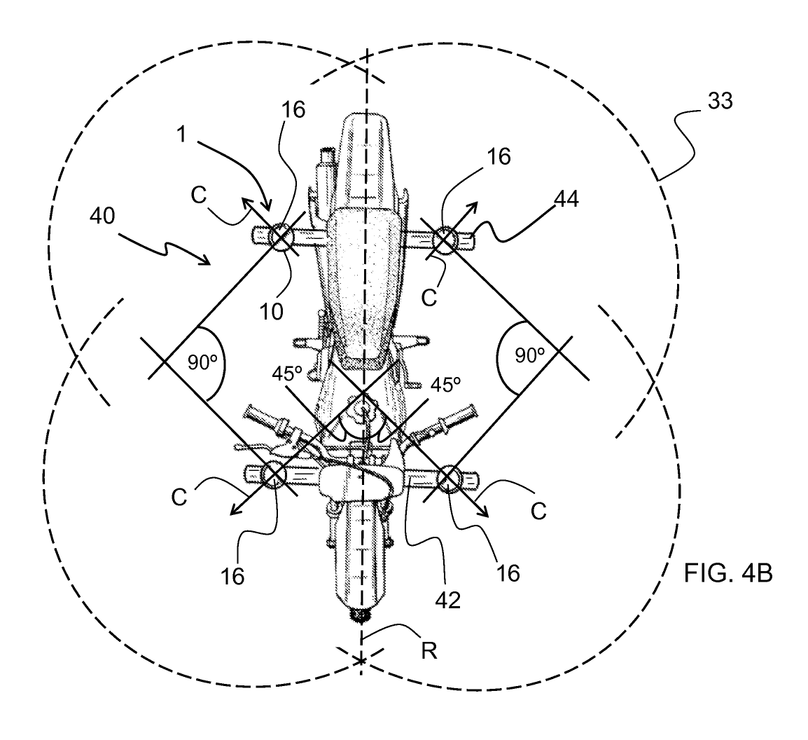

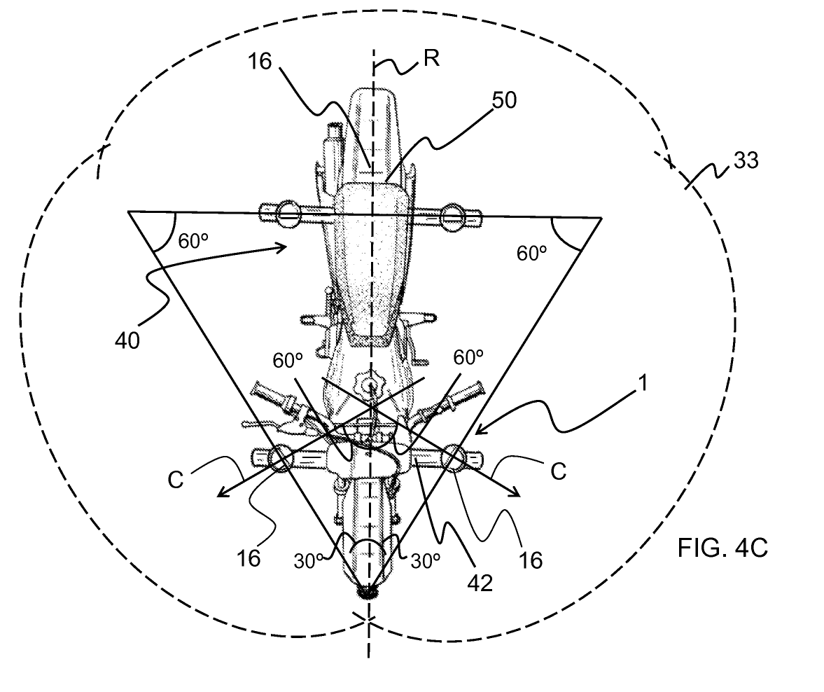

Turning to FIGS. 4A-C are an embodiment of the present invention which arranges three (3) and four (4) of the 180 degree emergency lights 16 with the above described mounting apparatus 1 to provide a complete 360 overlapping illumination coverage around the motorcycle. FIG. 4A illustrates a three (3) light illumination pattern with the 180 degree lights mounted on the front crash bars 42 oriented at approximately a 60 degree angle relative to the longitudinal axis R of the motorcycle. The rear 180 degree light 16 is mounted on a rear support bar 50 or similar support so that the entire rear emergency light 16 is oriented with its center line C co-linear with the longitudinal axis R of the motorcycle 40. In this way there are 3 overlapping illumination fans 33 which provide 360 degree illumination coverage around the entire motorcycle. The rear 180 degree light 16 may in actuality be two 180 degree lights 16 spaced apart on either side of the back of the motorcycle, and with their center lines C parallel with the axis R of the motorcycle so that each is providing an overlapping 180 degree illumination fan behind the motorcycle as shown in FIG. 4C.

FIG. 4B is another embodiment utilizing a 180 degree light and the above described mounting apparatus 10 on each of left and right side, front and rear crash bars 42, 44. The light mount 10 is attached to the front and rear crash bars on either side of the motorcycle 40 so that the center lines C of the lights 16 are each at a 45° angle relative to the longitudinal length R of the motorcycle and provides for greater overlap than the three light embodiment of FIG. 4A to provide complete illumination coverage around the entire motorcycle.

A still further embodiment provides that where one of the front and rear pair of lights is angled, for instance at 45 degrees, either the remaining front or rear lights may be angled so that the center lines C are parallel with the axis R. As shown in FIG. 4C, the use of the rear lights being directed rearward provides for more illumination to be visible towards the rear of the motorcycle for traffic approaching the motorcycle from behind, an important safety consideration. The resultant illumination fans 33 still ensure 360 degree illumination coverage around the entire motorcycle. It is possible to arrange the centerlines C of the lights 16 at other angles, however it is to be kept in mind that the preferred angles are those that ensure the illumination fans 33 of the lights 16 intersect as close to the motorcycle as possible to provide complete coverage of the motorcycle 40 immediately about the periphery of the motorcycle 40.

The invention has been described in detail with particular reference to certain preferred embodiments thereof, but it will be understood that variations and modifications can be effected within the spirit and scope of the invention.

I/We claim:

1. An apparatus for mounting emergency lights to a motorcycle comprising:
a plurality of light sources providing an illumination fan of approximately 180 degrees from each light source;
a mounting plate comprising a support surface for securely attaching the light source to the mounting plate;
at least a support bracket for removably affixing the mounting plate to a support structure on the motorcycle; and
wherein each of the plurality of light sources direct their respective illumination fan substantially equally on either side of a central illumination axis and the central illumination axis of each light source is directed at an angle of less than 90 degrees relative to a longitudinal axis of the motorcycle.

2. The apparatus for mounting emergency lights to a motorcycle as set forth in claim 1 further comprising a passage formed in the mounting plate to accommodate a power supply connected to the respective light source attached to the mounting plate.

3. The apparatus for mounting emergency lights to a motorcycle as set forth in claim 1 wherein the support bracket is affixed to a substantially tubular portion of the support structure on the motorcycle.

4. The apparatus for mounting emergency lights to a motorcycle as set forth in claim 3 wherein a pair of support brackets are attached at spaced apart points on the mounting plate and removably affixed to the substantially tubular portion of the support structure on the motorcycle.

5. The apparatus for mounting emergency lights to a motorcycle as set forth in claim 1 further comprising an elastic insulator sandwiched between an inner side of the support bracket and the support structure of the motorcycle to facilitate secure attachment and vibration damping between the support bracket and support structure.

6. The apparatus for mounting emergency lights to a motorcycle as set forth in claim 5 further comprising the elastic insulator also provided on an outer side of the support bracket to facilitate secure attachment and vibration damping between the support bracket and mounting plate.

7. The apparatus for mounting emergency lights to a motorcycle as set forth in claim 6 wherein the mounting plate is made of a metal alloy having a larger diameter than the light source so that the mounting plate protects the light source in the event of the motorcycle falling over.

8. The apparatus for mounting emergency lights to a motorcycle as set forth in claim 7 wherein a light source is mounted on a crash bar on opposing sides of the motorcycle and the central illumination axis of the light source on each opposing side is set in a predetermined position between about 45 and 60 degrees relative to the longitudinal axis of the motorcycle.

9. The apparatus for mounting emergency lights to a motorcycle as set forth in claim 8 wherein at least a rear light source is mounted on a rear portion of the motorcycle and the central illumination axis of the rear light source is set in a predetermined position between about 0 and 45 degrees relative to the longitudinal axis of the motorcycle.

10. An apparatus for mounting emergency lights to a motorcycle comprising:
a plurality of light sources providing an illumination fan of approximately 180 degrees from each light source;
a mounting plate comprising a support surface for securely attaching the light source to the mounting plate;
at least a support bracket for removably affixing the mounting plate to a support structure on the motorcycle and an elastic insulator positioned between the support bracket and the support structure of the motorcycle to facilitate secure attachment and vibration damping between the support bracket and support structure; and
wherein each of the plurality of light sources direct their respective illumination fan substantially equally on either side of a central illumination axis and the central illumination axis of each light source is directed at an angle of less than 90 degrees relative to a longitudinal axis of the motorcycle to ensure that each of the illumination fans of adjacent respective light sources overlap to provide illumination around the entire circumference of the motorcycle.

11. The apparatus for mounting emergency lights to a motorcycle as set forth in claim 10 further comprising a passage formed in the mounting plate to accommodate a power supply connected to the respective light source attached to the mounting plate.

12. The apparatus for mounting emergency lights to a motorcycle as set forth in claim 11 wherein the support bracket is affixed to a substantially tubular portion of the support structure on the motorcycle,

13. The apparatus for mounting emergency lights to a motorcycle as set forth in claim 12 wherein a pair of support brackets are attached at spaced apart points on the mounting plate and removably affixed to the substantially tubular portion of the support structure on the motorcycle

14. The apparatus for mounting emergency lights to a motorcycle as set forth in claim 13 wherein the mounting plate made of a metal alloy has a larger diameter than the light source so that the mounting plate protects the light source in the event of the motorcycle falling over.

15. The apparatus for mounting emergency lights to a motorcycle as set forth in claim 14 wherein a light source is mounted on a crash bar on opposing sides of the motorcycle and the central illumination axis of the light source on each opposing side is set in a predetermined position between about 45 and 60 degrees relative to the longitudinal axis of the motorcycle.

16. The apparatus for mounting emergency lights to a motorcycle as set forth in claim 15 wherein at least a rear light source is mounted on a rear portion of the motorcycle and the central illumination axis of the rear light source is set in a predetermined position between about 0 and 45 degrees relative to the longitudinal axis of the motorcycle.

17. A method of mounting emergency lights to a motorcycle comprising the steps of:
providing a plurality of light sources, each light source defining an illumination fan of approximately 180 degrees emanating from each light source;
attaching a mounting plate comprising a support surface to each light source for securely attaching the light source to the mounting plate;
removably affixing the mounting plate to a support structure on the motorcycle with a support bracket and positioning an elastic insulator between the support bracket and the support structure of the motorcycle to facilitate secure attachment and vibration damping between the support bracket and support structure; and
directing an illumination fan of each of the respective plurality of light sources substantially equally on either side of a central illumination axis of the light source and the central illumination axis of each light source is directed at an angle of less than 90 degrees relative to a longitudinal axis of the motorcycle to ensure that each of the illumination fans of adjacent respective light sources overlap to provide illumination around the entire circumference of the motorcycle.

18. The method of mounting emergency lights to a motorcycle as set forth in claim 17 further comprising the steps of mounting the light sources on a crash bar on opposing sides of the motorcycle and setting the central illumination axis of the light source on each opposing side between about 45 and 60 degrees relative to the longitudinal axis of the motorcycle.

19. The method of mounting emergency lights to a motorcycle as set forth in claim 18 further comprising the steps of mounting at least a rear light source on a rear portion of the motorcycle and the central illumination axis of the rear light source is set in a predetermined position between about 0 and 45 degrees relative to the longitudinal axis of the motorcycle.
